(19) United States
(12) Patent Application Publication
(10) Pub. No.: US 2007/0029702 A1
(43) Pub. Date: Feb. 8, 2007

(54) Thermoplastic elastomer bonded directly to metal substrate

(76) Inventors: Curt E. Peterson, Midland, MI (US); Richard T. Fox, Midland, MI (US)

Correspondence Address: THE DOW CHEMICAL COMPANY, INTELLECTUAL PROPERTY SECTION,, P. O. BOX 1967, MIDLAND, MI, 48641-1967, US

(21) Appl. No.: 11/580,174

(22) Filed: Oct. 12, 2006

Related U.S. Application Data
(62) Division of application No. 10/514,675, filed on Nov. 15, 2004.

(51) Int. Cl. B29C 45/14; B05D 1/36

(52) U.S. Cl. 264/259; 427/402

(57) ABSTRACT

Disclosed is a bonded assembly comprising a thermoplastic elastomer and a conversion coated metal substrate, a method to produce a bonded assembly comprising a thermoplastic elastomer and a conversion coated metal substrate and articles produced therefrom.

### CROSS REFERENCE STATEMENT

This application is a Divisional of prior application U.S. application Ser. No. 10/514,675, filed Nov. 15, 2004 and claims the benefit of priority from U.S. Provisional Application No. 60/388,882/, filed Jun. 14, 2002.

### FIELD OF THE INVENTION

The invention relates to bonding a thermoplastic elastomer directly to a metal substrate.

### BACKGROUND OF THE INVENTION

Bonding organic materials, such as thermoplastic elastomers to metal substrates is of great importance. One example of a growing industrial application which utilizes thermoplastic elastomers bonded to metal substrates is electronic enclosures, especially enclosures for rugged portable electronic equipment. The metal substrate provides protection to the delicate internal electronic components from rough treatment by providing tough impact resistance and can further provide electromagnetic shielding, environmental resistance and good-thermal management properties. In addition to the obvious ergonomic contribution such as the ‘soft-touch’ look and feel, the thermoplastic elastomer can further absorb energy upon impact, help in thermal-management and protect the electronic device from harsh environmental conditions. Moreover, the greatest contribution from the thermoplastic elastomer may come from function integration, such as forming living hinges and built-in weather sealing.

Thermoplastic elastomers and metals have different surface characteristics and varying degrees of compatibility. Normally, these chemically disparate materials peel apart easily. Thermoplastic elastomers have different atoms which affect surface bonding properties, such as nitrogen containing materials, oxygen containing materials, sulfur containing materials, silicone containing materials, halogen containing materials, and so on. Metals and metal alloys (collectively called metals) possess varying surface characteristics in regards to corrosion resistance, chemical resistance, types of oxides formed, and so on. For example, magnesium has a high sensitivity to salts such as chlorides. Magnesium also easily and quickly oxidizes. Magnesium oxide, formed by oxidation on a magnesium surface, is a very difficult surface on which to form a strong bond with other materials.

Numerous approaches have been devised to provide mechanisms and approaches to bonding these distinct materials, with varying degrees of success. Typically, bonding thermoplastic elastomers to metal substrates has required applying a primer layer to the metal and/or an adhesive layer to one or both of the metal and the thermoplastic elastomers, for example, see U.S. Pat. Nos. 6,287,411, 5,030,515, 4,297,159 4,857,131, and 5,268,404. Many adhesives are only useful in bonding specific elastomers to specific metal substrates and are thus lacking in versatility. Further, the use of primers and/or adhesive layers are time consuming and expensive. Bonding thermoplastic elastomers directly to metals without the need for primers and adhesive layers is therefore desired.

### SUMMARY OF THE INVENTION

The object of this invention is to provide a bonded assembly comprising a metal substrate bonded to a thermoplastic elastomer wherein a conversion coating is first applied to at least the bonding surface of the metal substrate and the thermoplastic elastomer bonds directly to the conversion coated metal substrate surface.

A further embodiment of the present invention is to provide a method to make a bonded assembly comprising a metal substrate bonded to a thermoplastic elastomer wherein a conversion coating is first applied to at least the bonding surface of the metal substrate and the thermoplastic elastomer bonds directly to the conversion coated metal substrate surface.

Yet a further embodiment of the present invention is a bonded assembly comprising a metal substrate bonded to a thermoplastic elastomer wherein a conversion coating is first applied to at least the bonding surface of the metal substrate and the thermoplastic elastomer bonds directly to the conversion coated metal substrate surface in the form of a fabricated article, for example, enclosures for portable electronic measurement data processing devices, enclosures for electronic devices such as housings for power tools and enclosures for information technology equipment such as telephones, computers, copiers, hand held computers, personal data assistants, cell phones, and the like.

### DETAILED DESCRIPTION OF THE INVENTION

The metal substrate suitable for use in the present invention comprise any of the common metals such as iron, steel (including stainless steel), lead, aluminum, copper, brass, bronze, nickel, zinc and preferably magnesium. Magnesium containing metals include pure magnesium, substantially pure magnesium and magnesium alloys. Magnesium alloys contain at least about 25 percent by weight magnesium, preferably at least about 50 percent, more preferably 75 percent and most preferably 85 percent by weight magnesium. Preferred magnesium alloys are disclosed in U.S. Pat. Nos. 6,287,411 and 5,040,589, both of which are incorporated herein by reference.

Magnesium alloys contain magnesium and one or more of an alkali metal, an alkaline earth metal, a transition metal, a rare earth metal, other metals and certain non-metals. General examples of magnesium alloys are alloys containing magnesium and one or more of aluminum, chromium, cobalt, copper, iridium, iron, gold, manganese, nickel, rare earth metals such as lanthanum, cerium, praseodymium, neodymium, promethium, samarium, europium, gadolinium, terbium, dysprosium, holmium, erbium, thulium, ytterbium, and lutetium, palladium, platinum, scandium, silicon, silver, tin, titanium, yttrium, zinc, and zirconium. Specific examples of magnesium alloys include the following ASTM designations: AM 100A; AZ63A; AZ81A; AZ91C,E; AZ92A; EZ23A; QE22A; WE43A; WE54A; ZE41A; ZK51A; ZK61A; AM50A; AE42X1; AM60A,B; AS41A,B; AZ91B,D; AZ31B,C; AZ61A; AZ80A; and ZK60A.

In one embodiment, the magnesium containing metal contains from about 25 percent to 100 percent by weight of magnesium and from 0 percent to about 75 percent by weight of one or more non-magnesium compounds, such as one or more of an alkali metal, an alkaline earth metal (but not magnesium), a transition metal, a rare earth metal, other metals and certain non-metals. In an other embodiment, the magnesium containing metal contains from about 50 percent to about 99 percent by weight of magnesium and from about 1 percent to about 50 percent by weight of one or more non-magnesium compounds or metals, such as from about 1 percent to about 50 percent by weight of aluminum. In yet another embodiment, the magnesium containing metal contains from about 75 percent to about 98 percent by weight of magnesium and from about 2 percent to about 25 percent by weight of one or more non-magnesium compound, such as from about 2 percent to about 25 percent by weight of aluminum, zinc and manganese.

Metal substrates may be produced by any means known in the art, such as stamping, machining, and die casting, preferably high-pressure die casting. In one embodiment, metal substrates are produced by injection molding of thixotropic metal alloys. U.S. Pat. Nos. 4,694,881, 4,694,882 and 5,040,589, all three incorporated by reference herein, disclose the conversion of a metal alloy having dendritic properties into a thixotropic, semisolid state by controlled heating so as to maintain the alloy above its solidus temperature and below its liquidus temperature while subjecting the alloy to a shearing action during injection molding. Thixotropically injection molded metal substrates demonstrate lower porosity and better flatness and tolerances than die cast metal substrate counterparts. Thixotropic injection molding is also ideally suited for thin-wall metal substrates used, for example, in hand held computers and analyzers, personal data assistants (PDAs) and cell phones.

Suitable thermoplastic elastomers for use in the present invention are block copolymers, preferably styrene block copolymers (S-TPE), such as polystyrene and polybutadiene, polystyrene and polyisoprene, polystyrene and poly(ethylene-co-butylene), and poly(α-methylstyrene) and polydimethysiloxane; thermoplastic polyolefin elastomers (TPOs) including metallocene catalyzed substantially linear ethylene polymers, metallocene catalyzed linear ethylene polymers, ethylene polypropylene rubber (EPR)/polypropylene blends, ethylene propylene diene (EPDM)/polypropylene blends, in-reactor propylene and ethylene copolymers and olefinic vulcanizates (TVPs); polyurethanes (TPUs), such as polyester based and polyether based; copolyesters (COPE), such as polycarbonate and polyester, polyether and polyester; polyamides (PEBAs); and silicone based rubbers, such as polydimethylsiloxane and polysulfone and polydimethylsiloxane and polycarbonate.

A good discussion of various thermoplastic elastomers is contained in Modern Plastics Encyclopedia/99, mid October 1998 Issue, Volume 75, Number 12, pp. 51-52 and Encyclopedia of Polymer Science and Engineering, 1986, Second Edition, Volume 5, pp. 416-430, the disclosure of which are incorporated herein by reference.

The term “block copolymer” is used herein to mean elastomers having at least one block segment of a hard polymer unit and at least one block segment of a rubber monomer unit. However, the term is not intended to include thermoelastic ethylene interpolymers which are, in general, random polymers. Preferred block copolymers contain hard segments of styrenic type polymers in combination with saturated or unsaturated rubber monomer segments. The structure of the block copolymers useful in the present invention is not critical and can be of the linear or radial type, either diblock or triblock, or any combination of thereof. Preferably, the predominant structure is that of triblocks and more preferably that of linear triblocks.

The preparation of the block copolymers useful herein is not the subject of the present invention. Methods for the preparation of such block copolymers are known in the art. Suitable catalysts for the preparation of useful block copolymers with unsaturated rubber monomer units include lithium based catalysts and especially lithium-alkyls. U.S. Pat. No. 3,595,942 describes suitable methods for hydrogenation of block copolymers with unsaturated rubber monomer units to from block copolymers with saturated rubber monomer units. The structure of the polymers is determined by their methods of polymerization. For example, linear polymers result from sequential introduction of the desired rubber monomer into the reaction vessel when using such initiators as lithium-alkyls or dilithiostilbene, or from coupling a two segment block copolymer with a difunctional coupling agent. Structures which behave rheologically like branched structures, on the other hand, are optionally obtained by the use of suitable coupling agents having a functionality with respect to the block copolymers with unsaturated rubber monomer units of three or more. Coupling is optionally effected with multifunctional coupling agents such as dihaloalkanes or alkenes and divinyl benzene as well as with certain polar compounds such as silicon halides, siloxanes or esters of monohydric alcohols with carboxylic acids. The presence of any coupling residues in the polymer is optionally ignored for an adequate description of the block copolymers forming a part of the composition of this invention.

Suitable block copolymers having unsaturated rubber monomer units include, but is not limited to, styrene-butadiene (SB), styrene-isoprene (SI), styrene-butadiene-styrene (SBS), styrene-isoprene-styrene (SIS), alpha-methylstyrene-butadiene-a-methylstyrene and alpha-methylstyrene-isoprene-alpha-methylstyrene.

The styrenic portion of the block copolymer is preferably a polymer or interpolymer of styrene and its analogs and homologs including alpha-methylstyrene and ring-substituted styrenes, particularly ring-methylated styrenes. The preferred styrenics are styrene and alpha-methylstyrene, and styrene is particularly preferred.

Block copolymers with unsaturated rubber monomer units optionally comprise homopolymers of butadiene or isoprene and copolymers of one or both of these two dienes with a minor amount of styrenic monomer. When the monomer employed is butadiene, it is preferred that between 35 and 55 mole percent of the condensed butadiene units in the butadiene polymer block have 1,2 configuration. Thus, when such a block is hydrogenated, the resulting product is, or resembles a regular copolymer block of ethylene and 1-butene (EB). If the conjugated diene employed is isoprene, the resulting hydrogenated product is or resembles a regular copolymer block of ethylene and propylene. Preferred block copolymers with saturated rubber monomer units comprise at least one segment of a styrenic unit and at least one segment of an ethylene-butene or ethylene-propylene copolymer. Preferred examples of such block copolymers with saturated rubber monomer units include styrene/ethylene-butene (SEB) copolymers, styrene/ethylene-propylene (SEP) copolymers, styrene/ethylene-butene/styrene (SEBS) copolymers, and styrene/ethylene-propylene/styrene (SEPS) copolymers.

Hydrogenation of block copolymers with unsaturated rubber monomer units is preferably effected by use of a catalyst comprising the reaction products of an aluminum alkyl compound with nickel or cobalt carboxylates or alkoxides under such conditions as to substantially completely hydrogenate at least 80 percent of the aliphatic double bonds while hydrogenating no more than 25 percent of the styrenic aromatic double bonds. Preferred block copolymers are those where at least 99 percent of the aliphatic double bonds are hydrogenated while less than 5 percent of the aromatic double bonds are hydrogenated.

The proportion of the styrenic blocks is advantageously between 8 and 65 percent by weight of the total weight of the block copolymer. Preferably, the block copolymers contain from 10 to 35 weight percent of styrenic block segments and from 90 to 65 weight percent of rubber monomer block segments, based on the total weight of the block copolymer. The average molecular weights of the individual blocks advantageously vary within certain limits. In most instances, the styrenic block segments have number average molecular weights (Mn) in the range of 5,000 to 125,000, preferably from 7,000 to 60,000 while the rubber monomer block segments have average molecular weights in the range of 10,000 to 300,000, preferably from 30,000 to 150,000. The total average molecular weight of the block copolymer is advantageously in the range of 25,000 to 250,000, preferably from 35,000 to 200,000. These molecular weights are as determined by tritium counting methods or osmotic pressure measurements.

Further, the various block copolymers suitable for use in the present invention are optionally modified by graft incorporation of minor amounts of functional groups, such as, for example, maleic anhydride by any of the methods well known in the art.

Block copolymers useful in the present invention are commercially available, such as, for example, supplied by Shell Chemical Company under the trade designation of KRATON and supplied by Dexco Polymers under the trade designation of VECTOR.

Thermoplastic polyolefin elastomers can roughly be divided into three categories:
1) B-TPOs, which are blends of a thermoplastic polyolefin, and a hydrocarbon rubber;
2) TPVs, which are blends of a thermoplastic polyolefin, and at least partially vulcanized hydrocarbon rubber;
3) R-TPOs, or reactor thermoplastic polyolefin elastomers, which are the product of a copolymerization of an elastomer segment on a thermoplastic polyolefin.
   The difference between categories 1) and 2) on the one hand, and category 3) on the other therefore lies in the fact that the former categories comprise blends and the latter category comprises copolymers. In all cases the morphology is that of a polyolefin resin, as a continuous matrix in which the elastomer is distributed, whether or not partially crosslinked, as a dispersed phase. When a R-TPO has been prepared the rubber component can also be at least partially vulcanized; since the rubber component is already anchored to the polyolefin resin, especially to the polyolefin component, this is not strictly necessary.

The thermoplastic polyolefinic component in the TPO can include thermoplastic crystalline polyolefin homopolymers and copolymers. These polyolefins can be prepared from monoolefin monomers having from 2 to 7 or more carbon atoms. Suitable such monolefins include ethylene, propylene, 1-butene, isobutylene, 1-pentene, 1-hexene, 1-octene, 3-methyl-1-pentene, 4-methyl-1-pentene, 5-methyl-1-hexene, a mixture of any thereof, and copolymers thereof with one or more functional unsaturated monomers, like (meth)acrylates and/or vinyl acetates. The monoolefins having from 3 to 6 carbon atoms may be preferred, and of these propylene is readily available.

The relative amount of polyolefin to rubber (matrix to dispersed phase) in the TPO can generally be from about 8 to about 90 weight percent polyolefin. The amount of polyolefin can be varied, but is typically in the range of about 10 to about 60 percent by weight of the thermoplastic elastomer component.

In principle, the dispersed phase in a suitable thermoplastic olefinic elastomer can be any rubber known to those skilled in the art. For instance, the rubber can comprise at least one copolymer rubber (for example, ethylene-propylene rubber), a terpolymer of ethylene, propylene and a non-conjugated diene (EPDM), and/or butyl rubber. As evident, in general, the rubbers can include butyl rubber (copolymer as well as terpolymers, and also in its halogenated form); ethylene/alpha-olefin copolymer rubber (EAM) as well as ethylene/alpha-olefin/diene terpolymer rubber (EADM); acrylonitrile/butadiene rubber (NBR); styrene/butadiene rubber (SBR); and natural rubber (NR). Use can also be made of an SB block copolymer, as described before. In case of EAM or EADM rubber, the alpha-olefin in such a rubber is preferably propylene; in such a case the rubber is referred to as EP(D)M.

A thermoplastic olefinic elastomer is called a thermoplastic olefinic elastomer vulcanizate (TPV) herein when the rubber in the TPO has a degree of vulcanization such that the amount of extractable rubber is less than 90 percent. The test to determine such an extractable amount is generally done with a solvent in which the polyolefin as well as the not-vulcanized rubber are soluble. A suitable solvent is boiling xylene. In principle, the rubber in the TPV is preferably vulcanized to the extent that the amount of extractable rubber is less than 15 percent, more preferred even less than 5 percent.

The thermoplastic elastomer can be fully or partially vulcanized with various vulcanization systems. The rubber in a TPO can be vulcanized with any vulcanization system that is known in the art. For instance, in the case of EA(D)M-rubber sulfur systems, peroxide systems and preferably vulcanization systems based on a phenolic resin are used. In general, suitable vulcanization agents and systems are described in Hoffman, “Vulcanization and Vulcanizing Agents”, Palmerton Publ. Co., N.Y., 1967, and in U.S. Pat. No. 3,806,558 and U.S. Pat. No. 5,021,500, the complete disclosures of which are incorporated herein by reference.

Suitable polyolefin elastomers for use in the present invention comprise one or more C₂ to C₂₀ alpha-olefins in polymerized form, having a glass transition temperature (T_{g}) less than 25° C., preferably less than 0° C. T_{g} is the temperature or temperature range at which a polymeric material shows an abrupt change in its physical properties, including, for example, mechanical strength. T_{g} can be determined by differential scanning calorimetry. Examples of the types of polymers from which the present polyolefin elastomers are selected include polyethylene and copolymers of alpha-olefins, such as ethylene and propylene, ethylene and 1-butene, ethylene and 1-hexene or ethylene and 1-octene copolymers, and terpolymers of ethylene, propylene and a diene comonomer such as hexadiene or ethylidene norbornene.

A preferred polyolefin elastomer is one or more substantially linear ethylene polymer or one or more linear ethylene polymer (S/LEP), or a mixture of one or more of each. Both substantially linear ethylene polymers and linear ethylene polymers are well known. Substantially linear ethylene polymers and their method of preparation are fully described in U.S. Pat. No. 5,272,236 and U.S. Pat. No. 5,278,272 and linear ethylene polymers and their method of preparation are fully disclosed in U.S. Pat. Nos. 3,645,992; 4,937,299; 4,701,432; 4,937,301; 4,935,397; 5,055,438; EP 129,368; EP 260,999; and WO 90/07526 the disclosures of which are incorporated herein by reference.

Various S/LEPs are commercially available from a number of companies under various tradenames, for example AFFINITY™ from The Dow Chemical Co., ENGAGE™ from du Pont Dow Elastomers, and EXXACT™ from Exxon Chemical, Inc.

Another preferred thermoplastic elastomer is a substantially random interpolymer prepared by polymerizing i) ethylene and/or one or more α-olefin monomers and ii) one or more vinyl or vinylidene aromatic monomers and/or one or more sterically hindered aliphatic or cycloaliphatic vinyl or vinylidene monomers, and optionally iii) other polymerizable ethylenically unsaturated monomer(s). Suitable alpha-olefins include for example, alpha-olefins containing from 3 to about 20, preferably from 3 to about 12, more preferably from 3 to about 8 carbon atoms. Particularly suitable are ethylene, propylene, butene-1,4-methyl-1-pentene, hexene-1 or octene-1 or ethylene in combination with one or more of propylene, butene-1,4-methyl-1-pentene, hexene-1 or octene-1. These alpha-olefins do not contain an aromatic moiety.

Suitable vinyl or vinylidene aromatic monomers which can be employed to prepare the interpolymers include, for example, those represented by the following formula: 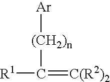
wherein R¹ is selected from the group of radicals consisting of hydrogen and alkyl radicals containing from 1 to about 4 carbon atoms, preferably hydrogen or methyl; each R² is independently selected from the group of radicals consisting of hydrogen and alkyl radicals containing from 1 to about 4 carbon atoms, preferably hydrogen or methyl; Ar is a phenyl group or a phenyl group substituted with from 1 to 5 substituents selected from the group consisting of halo, C₁₋₄-alkyl, and C₁₋₄-haloalkyl; and n has a value from zero to about 4, preferably from zero to about 2, most preferably zero. Exemplary vinyl aromatic monomers include styrene, vinyl toluene, α-methylstyrene, t-butyl styrene, chlorostyrene, including all isomers of these compounds, and the like. Particularly suitable such monomers include styrene and lower alkyl- or halogen-substituted derivatives thereof. Preferred monomers include styrene, α-methyl styrene, the lower alkyl-(C₁ to C₄) or phenyl-ring substituted derivatives of styrene, such as for example, ortho-, meta-, and para-methylstyrene, the ring halogenated styrenes, para-vinyl toluene or mixtures thereof, and the like. A more preferred aromatic vinyl monomer is styrene.

By the term “sterically hindered aliphatic or cycloaliphatic vinyl or vinylidene compounds”, it is meant addition polymerizable vinyl or vinylidene monomers corresponding to the formula: 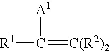
wherein A¹ is a sterically bulky, aliphatic or cycloaliphatic substituent of up to 20 carbons, R¹ is selected from the group of radicals consisting of hydrogen and alkyl radicals containing from 1 to about 4 carbon atoms, preferably hydrogen or methyl; each R² is independently selected from the group of radicals consisting of hydrogen and alkyl radicals containing from 1 to about 4 carbon atoms, preferably hydrogen or methyl; or alternatively R¹ and A¹ together form a ring system. Preferred aliphatic or cycloaliphatic vinyl or vinylidene compounds are monomers in which one of the carbon atoms bearing ethylenic unsaturation is tertiary or quaternary substituted. Examples of such substituents include cyclic aliphatic groups such as cyclohexyl, cyclohexenyl, cyclooctenyl, or ring alkyl or aryl substituted derivatives thereof, tert-butyl, norbornyl, and the like. Most preferred aliphatic or cycloaliphatic vinyl or vinylidene compounds are the various isomeric vinyl-ring substituted derivatives of cyclohexene and substituted cyclohexenes, and 5-ethylidene-2-norbornene. Especially suitable are 1-, 3-, and 4-vinylcyclohexene and 5-ethylidene-2-norbornene. Simple linear non-branched alpha-olefins including for example, alpha-olefins containing from 3 to about 20 carbon atoms such as propylene, butene-1,4-methyl-1-pentene, hexene-1 or octene-1 are not examples of sterically hindered aliphatic or cycloaliphatic vinyl or vinylidene compounds.

Other optional polymerizable ethylenically unsaturated monomer(s) include norbornene and C₁₋₁₀ alkyl or C₆₋₁₀ aryl substituted norbornenes, with an exemplary interpolymer being ethylene/styrene/norbornene.

Preferred substantially random interpolymers are the ethylene/propylene/styrene, ethylene/styrene/norbornene, and ethylene/propylene/styrene/norbornene interpolymers. The most preferred substantially random interpolymers are ethylene/styrene interpolymers. The substantially random interpolymers include the pseudo-random interpolymers as described in EP-A-0,416,815 by James C. Stevens et al. and U.S. Pat. No. 5,703,187 by Francis J. Timmers, both of which are incorporated herein by reference in their entirety.

A suitable thermoplastic polyurethane is any TPU blend having a Shore A hardness of not more than 95. Preferably, the TPU has a T_{g} less than 25° C. TPUs suitable for the present invention have a hard segment equal to or greater than about 15 weight percent, more preferably equal to or greater than 20, and most preferably equal to or greater than about 25 weight percent based on the total weight of the TPU. TPUs suitable for the present invention have a hard segment less than or equal to about 50 weight percent, more preferably less than or equal to about 40, and most preferably less than or equal to about 30 weight percent based on the total weight of the TPU. Preferably, the TPU has a soft segment of greater than or equal to about 50 weight percent, more preferably greater than or equal to about 60, and most preferably greater than or equal to about 70 weight percent based on the total weight of the TPU. TPUs suitable for the present invention have a soft segment less than or equal to about 85, more preferably less than or equal to about 80, and most preferably less than or equal to about 75 weight percent based on the total weight of the soft TPU.

Examples of materials used to create a TPU blend having a Shore A hardness of not more than 95 include natural butyl rubber, styrene-isoprene-styrene and styrene-butadiene-styrene triblock copolymers, and polyolefinic materials containing maleic anhydride grafts. The amounts of such materials used will, of course vary depending on the material and the hardness desired.

The hard segment of the TPU is a block derived from the reaction between a polyisocyanate and a difunctional chain extender. Preferred polyisocyanates include aromatic, aliphatic, and cycloaliphatic diisocyanates and combinations thereof. Representative examples of these preferred diisocyanates can be found, for example, in U.S. Pat. Nos. 4,385,133; 4,522,975; and 5,167,899. More preferred diisocyanates include 4,4′-diisocyanatodiphenylmethane, p-phenylene diisocyanate, 1,3-bis(isocyanatomethyl)cyclohexane, 1,4-diisocyanatocyclohexane, hexamethylenediisocyanate, 1,5-naphthalenediisocyanate, 3,3′-dimethyl-4,4′biphenyl diisocyanate, 4,4′-diisocyanatodicyclohexylmethane, and 2,4-toluenediisocyanate, or mixtures thereof. More preferred is 4,4′-diisocyanatodicyclohexylmethane and 4,4′-diisocyanatodiphenylmethane. Most preferred is 4,4′-diisocyanatodiphenylmethane.

The difunctional chain extender is a polyol having a molecular weight of not greater than 200. Preferred chain extenders are ethlyene glycol, 1,3-propanediol, 1,4-butanediol, 1,5-pentanediol, 1,6-hexanediol, diethylene glycol, tetraethylene glycol, neopental glycol, 1,4-cyclohexanedimethanol, 1,4-bishydroxyethylhydroquinone, and mixtures thereof. More preferred chain extenders are 1,4-butanediol, 1,6-hexanediol, and 1,4-cyclohexanedimethanol, and mixtures thereof.

The soft segment of the TPU is derived from a polyol which has a weight average molecular weight (Mw) in the range preferably equal to or greater than about 500, more preferably equal to or greater than about 1000, most preferably equal to or greater than about 1500, but preferably equal to or less than about 6000, more preferably equal to or less than about 4000, and most preferably equal to or less than about 3000. The polyol is preferably a polyester polyol or a polyether polyol or combinations thereof. Examples of preferred polyester polyols and polyether polyols include polycaprolactone glycol, polyoxyethylene glycol, polyoxypropylene glycol, polyoxyethylene/polyoxypropylene glycol copolymer, polyoxytetramethylene glycol, polyethylene adipate, polybutylene adipate, polyethylene-butylene adipate, and poly(hexamethylene)carbonate glycol, or combinations thereof.

The TPU preferably has a Shore A durometer hardness of 90 or less. Preferably, the TPU has a Shore A durometer hardness of 80 or less, more preferably 75 or less.

Various TPUs are commercially available from a number of companies under various tradenames, for example PELLETHANE™ TPU Resins from The Dow Chemical Co., ESTANE™ from B.F. Goodrich Chemical Co., and DESMOPAN™ from Bayer Corporation.

The copolyester elastomer is advantageously a copolyetherester consisting essentially of a multiplicity of recurring long chain ester units and short chain ester units joined head-to-tail through ester linkages. The long chain ester units are represented by the formula: 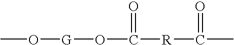
and the short-chain ester units are represented by the formula: 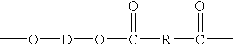
where G is a divalent radical remaining after removal of terminal hydroxyl groups from a poly(alkylene oxide) glycol having a molecular weight of about 400-6000 and a carbon-to-oxygen ratio of about 2.0-4.3; R is a divalent radical remaining after removal of carboxyl groups from a dicarboxylic acid having a molecular weight less than about 300 and D is a divalent radical remaining after removal of hydroxyl groups from a diol having a molecular weight less than about 250; provided said short chain ester units amount to about 15 to 95 percent by weight of the copolyetherester.

Alternatively, the copolyester elastomer is a copolyesterester.

Copolyetherester elastomers and copolyesterester elastomers are described or example in U.S. Pat. Nos. 4,981,908; 5,824,421 and 5,731,380, the descriptions hereof are incorporated herein by way of reference.

Polyetherester block copolymers and their preparation are also described in Encyclopedia of Polymer Science and Engineering, Volume 12, pages 76-177 (1985) and the references reported therein.

Various polyetherester block copolymers are commercially available from a number of companies under various tradenames, for example HYTREL™ of E.I. du Pont de Nemours, RITEFLEX™ of Ticona, GAFLEX™ of GAF and ARNITEL™ of DSM.

Varying the ratio hard/soft segment and using different alkylene oxides and molar weights of the soft segments makes it possible to obtain block copolyesters having different harnesses, for example between Shore D 30 and 80.

Depending on the desired pattern of characteristics, persons skilled in the art will be able to select the polyetherester block copolymer for the compositions according to the invention.

In many embodiments, it is preferable to clean at least the bonding surface of the metal substrate prior to bonding with the thermoplastic elastomer. Cleaning may be conducted by at least one of a water-rinse, deionized water rinse, a dilute acid wash, and a mild acid wash. Any mineral or organic acid may be employed to wash the metal surface, so long as the surface of the metal is not substantially degraded or damaged.

Prior to bonding the thermoplastic elastomer to the metal substrate, at least the bonding surface of the metal substrate is treated with a conversion coating. Non-bonding surfaces may additionally be treated with the conversion coating. In one embodiment, the metal is contacted with a chromate solution prior to bonding with the thermoplastic elastomer. A chromate solution contains water and chromate ions. The chromate solution does not deposit any substantial amount of a coating on the metal, but it does alter the surface via oxidation. Contact is accomplished by spraying or dipping the metal in a chromate solution. Chromate may be derived from a number of sources including chromic acid, sodium dichromate, potassium chromate and magnesium chromate. The chromate solution may further contain additives including at least one of hybrofluozirconic acid and fluoroboric acid. The composition of the chromating bath depends on the metal to be treated. Examples of suitable chromate conversion coatings are ALODINE™ 600 and 1200 available from Henkel. A preferred chromate conversion coating, preferably for aluminum and magnesium metal, is NH35 available from Valmont Applied Coating Technology, Mendota Heights, Wis. The chromate conversion coating may be applied by any means known in the art, preferably, spraying or immersion. A good discussion of chromate conversion coatings can be found in Metals Handbook, 9^{th} Edition, Volume 13 Corrosion, 1987, pp. 389 to 395, which is incorporated herein by reference.

In one embodiment, the concentration of chromate in the chromate solution is from about 0.1 gram per liter (g/l) to about 25 g/l. In another embodiment, the concentration of chromate in the chromate solution is from about 1 g/l to about 5 g/l. In one embodiment, the metal is in contact with the chromate solution from about 2 seconds to about 2 minutes, preferably from about 5 seconds to about 1 minute, and more preferably from about 10 seconds to about 30 seconds.

In one embodiment, the metal is contacted with a phosphate coating prior to bonding with the thermoplastic elastomer. Suitable phosphate coatings are iron phosphates, zinc phosphates or heavy phosphates. The basic process involved in the formation of any phosphate coating is in the precipitation of a divalent metal and phosphate ions (PO₄⁻³) on a metal surface. Accelerators known to those skilled in the art may be employed to hasten the phosphating process. The phosphate conversion coating may be applied by any means known in the art, preferably, spraying or immersion. A good discussion of phosphate coatings can be found in Metals Handbook, 9^{th} Edition, Volume 13 Corrosion, 1987, pp. 383 to 388.

In one embodiment, the metal is contacted with a chromium-free conversion coating based on titanium and zirconium compounds. Many of the compositions of such conversion coatings are propriety. Examples of suitable chromate-free coatings are PERMATREAT™ 615M, 617M, 604A and 686A from Betz Metchem, AKLIMATE™ from Bi-K Corp., OXSILAN™ 0500 and PYRENE™ 777 from Brent America, AL9210 from CHEMAT, ALODINE 2000, 2600, and 5200 from Henkel, CHEMIDIZE™ 727 from MacDermid, CHEMCOAT™ 4500 from Oakite, SAFEGARD™ CC-3400 and CC-7000 from Sanchem and ZIRCONOX™ from Natural Coating Systems. A preferable chromium-free conversion coating, preferably for aluminum and magnesium metal is ALODINE 5200 available from Henkel Surface Technologies, Madison Heights, Mich. The chromium-free conversion coating may be applied by any means known in the art, preferably, spraying or immersion.

The thermoplastic elastomer is conveniently bonded to the conversion coating treated metal substrate using an overmolding process, sometimes referred to as an insert-molding process. Overmolding is well known in the art and is a process whereby a substrate, in this case the conversion coated metal substrate, is inserted into a mold in which the thermoplastic elastomer is overmolded yielding a bonded assembly comprising a metal substrate bonded to a thermoplastic elastomer. Examples of molding processes suitable for overmolding are compression molding or preferably injection molding. The metal substrate can be room temperature or heated prior to mold insertion. One skilled in the art can select an appropriate temperature for the overmolding process depending on the thermoplastic elastomer and the metal substrate used.

The metal substrate has a topside, a bottom side and a thickness (for example, its sides). The thickness of the metal substrate of the present invention is equal to or greater than about 0.01 inches (in.) (0.25 mm), preferably equal to or greater than about 0.02 in. (0.51 mm) and most preferably equal to or greater than about 0.03 in. (0.76 mm). The thickness of the metal substrate of the present invention is equal to or less than about 0.3 in. (7.62 mm), preferably equal to or less than about 0.2 in. (5.08 mm) and most preferably equal to or less than about 0.1 in. (2.54 mm). The thermoplastic elastomer may be bonded to the topside and/or the bottom-side and/or the side(s) of the metal substrate.

In one embodiment, the metal substrate is designed to allow for one or more mechanical locks between the thermoplastic elastomer and the metal substrate. For example, the metal substrate may contain one or more grooves, holes, undercuts, depressions, ribs, gripper teeth, or combinations thereof, and the like, wherein the thermoplastic elastomer is molded into, onto, around or through providing a mechanical lock between the thermoplastic elastomer and the metal substrate.

### EXAMPLES

In Comparative Examples A to C and Examples 1 to 6, thermoplastic elastomers are overmolded onto THIXOMOLDED™ injection molded magnesium blank plates available from Thixomat. The THIXOMOLDED magnesium is an AZ91D alloy, comprising 9 percent Al, 1 percent Zn and trace Mn content having a density of 1.82 grams per centimeter (g/cc). The blank plates have a thickness of about 0.06 in. (1.52 mm) and are edge-machined into inserts retaining as-molded surfaces for elastomer contact. The insert plates for overmolding metal substrates measure about 1.24 in. (31.5 mm) by 3.774 in. (95.86 mm) by 0.06 in. (1.52 mm).

In Comparative Examples A to C the thermoplastic elastomer is overmolded onto the as-molded surface of the THIXOMOLDED magnesium blank. In Examples 1 to 6 the thermoplastic elastomer is overmolded onto a THIXOMOLDED magnesium blank treated with a conversion coating. The conversion coatings are applied to the THIXOMOLDED magnesium blanks by Applied Coating Technology, Inc. (Eden Prairie, Minn.).

A 22 ton Battenfeld reciprocating screw injection molding machine, having a 14:1 length:diameter screw is used. Approximate melt processing temperatures are: SARLINK 6555: 193° C. (380° F.), Teknor Apex 1728: 196° C. (385° F.), and PELLETHANE 2103-70A TPU: 204° C. (400° F.), all are molded with room temperature mold and insert.

The mold is a single cavity mold consisting of a rectangular cavity of about 3.775 in. (95.89 mm) by 1.25 in. (31.75 mm) by 0.3 in. (7.62 mm). The mold cavity is fed by a 0.25 in. (6.35 mm) diameter semicircular gate having a cross sectional area measuring 0.0245 square in. (0.62 sq. mm) Brass retaining inserts measuring about 0.26 in. (6.6 mm) wide are placed at each end of the cavity to retain the insert plate in position when the mold halves are closed; one has a gate machined within to allow material to enter the cavity. Following molding, the brass retaining inserts are removed from either end, yielding a layer of thermoplastic elastomer measuring about 3.25 in. (82.55 mm) by 1.24 in. (31.50) by 0.24 in. (6.1 mm) bonded to THIXOMOLDED magnesium metal substrate. The runner is not removed and used as the attachment point for delamination/peel testing.

The compositions of Comparative Examples A to C and Examples 1 to 6 are listed in Table 1. In Table 1:

“SEBS” is Teknor Apex 1728-L3 S-EB-S type thermoplastic elastomer available from Teknor Apex available from Teknor Apex, Pawtucket, R.I.;

“TPV” is SARLINK 6555 a two phase polypropylene/EPDM thermoplastic vulcanizate available from DSM Thermoplastic Elastomers;

“TPU” is PELLETHANE 2103-70A TPU, a polyester polycaprolactone-based polyurethane elastomer, available from The Dow Chemical Company, Midland, Mich.;

“ALODINE 5200” is a proprietary chromium-free organic fluoride-containing propoxypropanol conversion coating available from Henkel Surface Technologies, Madison Heights, Mich. and “NH35” is a proprietary chromium-containing conversion coating available from Applied Coatings, Eden Prairie, Minn.

The adhesion of the thermoplastic elastomer to the magnesium surfaces is assessed through fixturing samples within an INSTRON™ testing device such that the magnesium base is clamped and subjecting the overmolded thermoplastic elastomer to tensile loads applied normal to the 3.25 in. (82.55 mm) by 1.24 in. (31.5 mm) face, and from the 1.24 in. (31.5 mm) wide end of the specimen. Measured tensile load is a reflection of the force required to overcome polymer/magnesium face adhesion at that specimen width and sustain the delamination via peeling. INSTRON testing machine frame specimen grip was attached to the runner, which is molded into the thermoplastic elastomer overmold. A 0.5 inch/minute (in./min.) (12.7 mm/min.) crosshead speed is utilized for all examples. Adhesion results are the maximum load experienced by the sample during peeling and are reported in Table 1 in pounds (lbs.).

TABLE 1

| | | Thermoplastic | | | | | | Maximum | |
|---|---|---|---|---|---|---|---|---|---|
| Com. | | Elastomer | | | Conversion Coating | | | Load, lbs. | |
| Ex | Ex. | SEBS | TPV | TPU | As molded | ALODINE 5200 | NH35 | (Kg) | |
| A | | X | | | X | | | 2.5 | (1.13) |
| | 1 | X | | | | X | | 16.2* | (7.35) |
| | 2 | X | | | | | X | 14* | (6.35) |
| B | | | X | | X | | | 0.25 | (0.11) |
| | 3 | | X | | | X | | 11.5* | (5.22) |
| | 4 | | X | | | | X | 12* | (5.44) |
| C | | | | X | X | | | 0.75 | (0.34) |
| | 5 | | | X | | X | | 37 | (16.78) |
| | 6 | | | X | | | X | 30.5 | (13.83) |

*Indicates the thermoplastic elastomer failed before the layer began to peel away from the mg substrate

From the results listed in Table 1 it can clearly be seen that the relative load required to overcome magnesium/thermoplastic elastomer adhesion for substrates treated with ALODINE 5200 and NH35 conversion coatings are significantly improved versus the untreated blanks. Further, in Examples 1 to 4 the force required to delaminate the TPV and SEBS exceeds the capacity of the material to support the load within a 0.025 square in. (0.64 sq. mm) (cross-section elastomer tab tethered to the crosshead grips.

1. A method to make a bonded assembly comprising the steps of
(i) obtaining a metal substrate,
(ii) coating at least one surface of the metal substrate with a conversion coating,
(iii) overmolding a thermoplastic elastomer directly to the at least one conversion coated surface of the metal substrate and
(iv) forming a resulting bonded assembly.

2. The method of claim 1 wherein the metal substrate comprises iron, steel, lead, aluminum, copper, brass, bronze, nickel, zinc, magnesium or alloys thereof.

3. The method of claim 1 wherein the metal substrate is produced by injection molding, stamping, machining, or die casting.

4. The method of claim 1 wherein the metal substrate is produced by injection molding a thixotropic metal alloy.

5. The method of claim 1 wherein the metal substrate is produced by injection molding a thixotropic magnesium alloy.

6. The method of claim 1 wherein the thermoplastic elastomer is a styrene block copolymer, a thermoplastic polyolefin elastomer, a polyurethane, a polyamide or a silicone based rubber.

7. The method of claim 1 wherein the thermoplastic elastomer is a polystyrene and polybutadiene block copolymer, a polystyrene and polyisoprene block copolymer, a polystyrene and poly(ethylene-co-butylene) block copolymer, a poly(α-methylstyrene) and polydimethysiloxane block copolymer, a metallocene catalyzed substantially linear ethylene polymer, a metallocene catalyzed linear ethylene polymer, an ethylene polypropylene rubber/propylene blend, a ethylene propylene diene/polypropylene blend, an in-reactor propylene and ethylene copolymer, an olefinic vulcanizate, a copolyesterester, a copolyetherester, a polydimethylsiloxane and polysulfone blend or a polydimethylsiloxane and polycarbonate blend.

8. The method of claim 1 wherein the thermoplastic elastomer is a polyester polycaprolactone-based polyurethane elastomer, a S-EB-S type thermoplastic elastomer, or a two phase polypropylene/EPDM thermoplastic vulcanizate.

9. The method of claim 1 wherein the conversion coating comprises chromium.

10. The method of claim 1 wherein the conversion coating is a chromium-free conversion coating based on titanium and zirconium compounds.

11. The method of claim 1 wherein the conversion coating is a chromium-free conversion coating based phosphate.

12. The method of claim 1 wherein the bonded assembly is in the form of a fabricated article.

13. The method of claim 1 wherein the bonded assembly is an enclosure for a portable electronic measurement data processing device, a power tool, a telephone, a computer, a copier, a hand held computer, a personal data assistant or a cell phone.
